(19) United States
(12) Patent Application Publication
(10) Pub. No.: US 2011/0223903 A1
(43) Pub. Date: Sep. 15, 2011

(54) Apparatus And Method For Synchronization

(75) Inventors: Juergen Michel, Munich (DE); Bernhard Raaf, Neuried (DE)

(73) Assignee: Nokia Siemens Network OY, Espoo (FI)

(21) Appl. No.: 13/128,044

(22) PCT Filed: Nov. 7, 2008
(86) PCT No.: PCT/EP08/65125

§ 371 Date: May 23, 2011

(51) Int. Cl. H04W 24/00

(52) U.S. Cl. 455/422.1

(57) ABSTRACT

Embodiments provide a method and apparatus configured to measure a timing difference to at least one neighbouring base station, cell, NodeB, enhanced NodeB, relay and/or relays, evaluate or generate a time control command depending on the measured timing difference, and send the time control command to a serving base station or NodeB or eNB.

### FIELD OF TECHNOLOGY AND BACKGROUND

The invention generally relates to communication and network elements, methods, apparatuses, systems and programs of or for communication. Further, embodiments of the invention relate to mobile wireless communications, such as third generation partnership project, 3GPP, long-term evolution, LTE, or 3GPP long-term evolution advanced, LTE-A or LTE-Advanced (term used for the evolution of LTE).

Link performance of LTE frequency division duplex, FDD, system is very close to Shannon limit which means that from pure link perspective the LTE is already nearly optimum. Therefore only minor link level improvements with limited gains are possible like improved coding and modulation efficiency or improved HARQ (hybrid automatic repeat request).

Therefore, technologies considered for LTE-Advanced are mainly those which can improve the average bandwidth or signal-to interference plus noise ratio, SINR, experienced by a user. This can be achieved for example by interference coordination, coordinated multipoint transmission, multi-antenna solutions and/or by the introduction of relays or repeaters in accordance with one or more implementations of the invention.

For synchronization decentralized and over the air synchronization methods may be considered.

A decentralized synchronization scheme may allow achieving a locally common frame timing by a mutual adaptation of the individual frame timing.

In another implementation, base stations may be equipped with GPS receivers and utilize the GPS time signature as a common reference for frame and in TDD also switching point timing. Such a GPS implementation leads to additional costs due to the GPS receivers. Further, GPS signals may not always be available or strong enough e.g. in indoor or downtown scenarios.

In case e.g. LTE or LTE-A networks of different operators are to be synchronized (adjacent channel case), network timing of both operators should be synchronized in principle which can not be done easily over the backhaul itself. Therefore several over the air synchronisation procedures have been studied. Network synchronization may be used as synchronization method. Yet, jitter of cable connections may limit the synchronization accuracy over the network. A network time protocol, NTP (network synchronization protocol), may be used.

### SUMMARY

In accordance with at least one or more embodiments in accordance with the invention, an apparatus is provided which is configured to measure a timing difference to at least one neighbouring base station, cell, NodeB, enhanced NodeB, and/or relay,

evaluate or generate a time control command depending on the measured timing difference, and
send the time control command to a serving base station or NodeB or enhanced NodeB.

In accordance with one or more embodiments, the time control command may e.g. be a single-bit or multi-bit command.

In accordance with one or more embodiments, the apparatus may be configured to measure timing of downlink signals, or primary and secondary synchronization signals.

In accordance with one or more embodiments, the apparatus may e.g. be a relay or part, module, chipset, or software of a relay.

In accordance with one or more embodiments, the apparatus may e.g. be configured to be connected to its serving or feeding NodeB or enhanced NodeB or base station.

In accordance with one or more embodiments, the apparatus may e.g. be configured to signal or indicate, e.g. by cell identity or site identity, to which base station or NodeB or enhanced NodeB it is connected, and to utilize at least one or more of base stations or NodeBs and relays to achieve time synchronization.

In accordance with one or more embodiments, an apparatus may be configured to receive a time control information and to update its timing depending on the received time control information.

In accordance with one or more embodiments, an apparatus may e.g. be configured to receive at least two time control information from at least two relays, and to process, such as by summing or averaging or weighted averaging, the received at least two time control information.

In accordance with one or more embodiments, an apparatus may be configured to shift or delay the timing of a sub-frame to provide synchronization.

In accordance with one or more embodiments, the apparatus may e.g. be a relay or part, module, chipset, or software of a base station, NodeB or enhanced NodeB.

In accordance with one or more embodiments, a method may comprise measuring a timing difference to at least one neighbouring base station, cell, NodeB, relay and/or relays, evaluating or generating a time control command depending on the measured timing difference, and

sending the time control command to a serving base station or NodeB or enhanced NodeB.

In accordance with one or more embodiments, a method may comprise, or an apparatus may be configured to, at least one or more, in any arbitrary combination, of the following:
the time control command is a single-bit or multi-bit command,
measuring timing of downlink signals, or primary and secondary synchronization signals;
implementing the method in a relay or part, module, chipset, or software of a relay,
connecting a relay to its serving or feeding NodeB or enhanced NodeB or base station,
signaling or indicating, e.g. by cell identity or site identity, to which base station or NodeB or enhanced NodeB it is connected, and
utilizing at least one or more of base stations and relays to achieve time synchronization.

In accordance with one or more embodiments, a method may comprise
receiving a time control information, and
updating a timing depending on the received time control information.

In accordance with one or more embodiments, a method may e.g. comprise at least one or more, in any arbitrary combination, of the following:
receiving at least two time control information from at least two relays,
processing, such as summing or averaging or weighted averaging, the received at least two time control information,
shifting or delaying the timing of a sub-frame to provide synchronization,
implementing the method in a base station or part, module, chipset, or software of a base station, NodeB or enhanced NodeB.

In accordance with one or more embodiments, a computer program product, program or software is provided, comprising code means configured to carry out or implement, when run on a processor, a method as defined above or below. The program or software or product may e.g. be embodied on a computer readable recording medium such as e.g. a portable or installed storage medium.

In accordance with one or more embodiments, a synchronization of one or more networks or systems such as LTE-A with relays is provided. In accordance with one or more embodiments networks such as LTE systems e.g. frequency division duplex, FDD, system, may be equipped with relays. Time synchronization of or to neighbour cells is provided in accordance with one or more embodiments of the invention. Even when deploying e.g. LTE FDD unsynchronized in time, effective network synchronization can be provided. In accordance with one or more embodiments of the invention, relays provide a synchronization of networks such as e.g. LTE-A FDD networks.

One or more embodiments of the invention relate to mobile wireless communications, such as 3GPP Long-Term Evolution or 3GPP Long-Term Evolution Advanced (LTE & LTE-A) and more specifically to the field of over the air network synchronization with decentralized algorithms. In accordance with one or more embodiments of the invention, network synchronization is provided e.g. for relay systems with decode and forward type relays to minimize the impact of interference and to enable the possibility of resource partitioning in time.

Embodiments in accordance with the invention are applicable e.g. for both FDD and TDD technologies as well as for other technologies and can also be adopted to other mobile communication systems other than LTE. In accordance with one or more embodiments of the invention a solution is provided for access networks such as a radio access network, RAN, implying at least one or more of relay nodes, base stations and user equipments (UEs).

In accordance with one or more of the embodiments of the invention, a computer program or software product is provided which comprise code means configured to carry out or implement, when run on a processor, one or more of the steps or processes or methods as described above or below. The computer program may e.g. be embodied on a computer-readable medium.

Other objects, features and advantages of the invention will become apparent from the following description of embodiments of the invention.

### BRIEF DESCRIPTION OF DRAWINGS

FIG. 1 illustrates an example of a timing adaption;

FIG. 2 shows an example of a resource partitioning scheme;

FIG. 3 illustrates an embodiment of a cellular network with relay;

FIG. 4 shows an embodiment in accordance with the invention;

FIG. 5 shows a method in accordance with an embodiment of the invention;

FIG. 6 illustrates an embodiment of a relay or relay node in accordance with the invention;

FIG. 7 shows an embodiment of a base station or eNB in accordance with the invention;

FIG. 8 shows a comparison of single versus multi-neighbour scheme;

FIG. 9 shows a comparison of single versus multi-bit reporting; and

FIG. 10 illustrates the impact of network size on the needed synchronization time.

### DESCRIPTION OF EMBODIMENTS

The synchronization procedure may comprise acquiring a frame timing of a received LTE primary and secondary synchronization signal (PSS, SSS), or potentially other signals including data signals, reference signals or signals specifically transmitted for this purpose and adapting the own frame timing according to the observed time difference to the received neighbour base station or NodeB or enhanced NodeB, eNB. For acquisition of received LTE frame timing difference, a correlation based scheme can be used. In detail, for LTE or LTE-A, a correlation to the primary synchronization signal PSS and secondary synchronization signal SSS may be done.

Devices connected to or camping on a eNB Xₖ may be utilized to measure the timing difference of PSS and SSS to a received neighbour eNB Xᵢ and the evaluation may be done by determining the time difference Δtᵢₖ between the correlation maxima related to the own and the neighbour eNB PSS and SSS signal. Then at the end of the timing difference measurement and acquisition phase, each eNB Xₖ may adapt its own timing tₖ according to

t_{k,new}=t_{k,old}+w×Δtᵢₖ,

where the parameter w denotes a weighting factor (w<1) and the value Δtᵢₖ may be measured at the UE and signalled to the eNB.

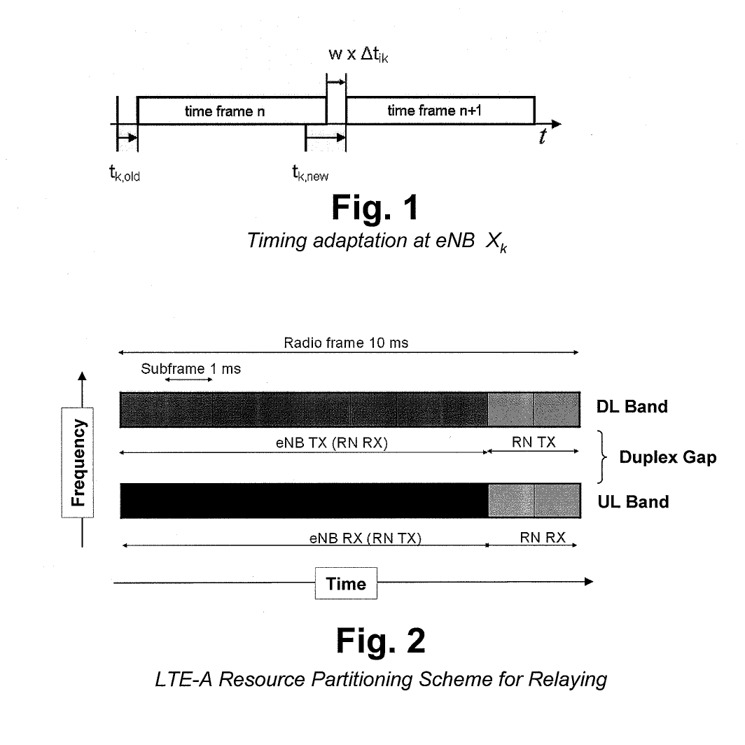

A timing adaptation of eNB Xₖ is shown in FIG. 1. Within frame n, one or more devices may measure a time offset of Δtᵢₖ with respect to eNB Xᵢ and transmit the information regarding Δtᵢₖ either by layer 1 signalling or higher layer signalling (e.g. layer 2 or layer 3 measurement reports) to the eNB Xₖ. According to above equation eNB Xₖ shifts the start position of the next frame n+1 by w×Δtᵢₖ. Since all eNBs may participate in the mutual synchronization procedure, a locally common frame timing can be achieved.

When relying for such decentralized synchronisation algorithms on user equipment (UEs) for carrying out the measurements, presence of such user equipments is needed. Further, there is a high amount of signalling between UEs and eNB (signalling of timing difference) which may lead to increased battery consumption at UEs and increased utilization of uplink, UL, physical air interface resources for signalling.

Further, dependent on the Δtᵢₖ measurement and w the applied time shift w×Δtᵢₖ at the eNB may be rather high, causing UEs connected to eNB Xₖ to be unable to decode downlink channels correctly after timing adaptation if they are not able to track or follow the time shift done at eNB.

In FIG. 2, a possible resource partitioning scheme for an extension of an LTE FDD system is shown. Relays are introduced in this embodiment. FIG. 2 illustrates an embodiment of an LTE-A resource partitioning scheme for relaying. In the upper part the downlink DL frame structure can be seen. For avoiding that eNB and relay nodes, RNs, transmit at the same time the first e.g. eight sub-frames are allocated for eNB to RN and eNB to UE transmission and the last two sub-frames are allocated to RN to UE transmission.

This kind of resource partitioning is provided since RNs should optionally not transmit to UEs and at the same time and in the same band receive data from an eNB due to the fact that high interference would be caused from the own RN to UE transmission so that a weaker received signal from eNB may not be properly decoded.

A radio frame may have a duration of e.g. 10 ms, comprising ten sub-frames of 1 ms duration each. The frequency of the downlink band is higher than that of the uplink band with a duplex band in between. For the first e.g. eight sub-frames of the downlink, the eNB may transmit (with the relay node receiving), and for the last two sub-frames the relay node may be in transmitting mode. For the first e.g. eight sub-frames of the uplink, the eNB may receive (with the relay node transmitting), and for the last two sub-frames the relay node may be in receiving mode. The resource partitioning may be aligned not only between the feeding eNB and its relays but also between relays and eNBs in neighboring cells and as a consequence also between relays connected to neighboring feeding eNBs.

Actually the relay nodes may more often transmit, e.g. to their subordinate UEs, so the split of 8/2 shown in FIG. 2 may also be reversed to 2/8 or another setting, including using multiple switching between the two modes of operation within a single 10 ms frame.

In accordance with one or more embodiments of the invention a time synchronization of neighbor cells is provided, allowing e.g. the introduction of relays or in other words an extension of the LTE FDD system with relays.

Means, apparatuses, functions and software are provided in accordance with one or more embodiments for effective network synchronization even in case e.g. LTE FDD is deployed unsynchronized in time. Therefore an extension of systems e.g. LTE FDD systems to newer systems such as e.g. LTE-A FDD (LTE advanced) systems that utilize relays e.g. to enhance cell edge performance, is easily possible.

In accordance with one or more embodiments of the invention, relays in principle solve the problem they are creating. In other words if relays are introduced in a network such as e.g. LTE-A FDD the network will be operated synchronized in time in accordance with one or more embodiments of the invention. With the embodiments described above and below relays provide a solution to synchronize LTE-A FDD networks and other types of networks or systems such as time division duplex networks, code division networks, multiple access networks etc.

An advantage of the above approach is that no other means need to be provided for synchronization than the means that are there anyhow. In particular no additional nodes need to be deployed and no additional receivers or transmitters need to be installed.

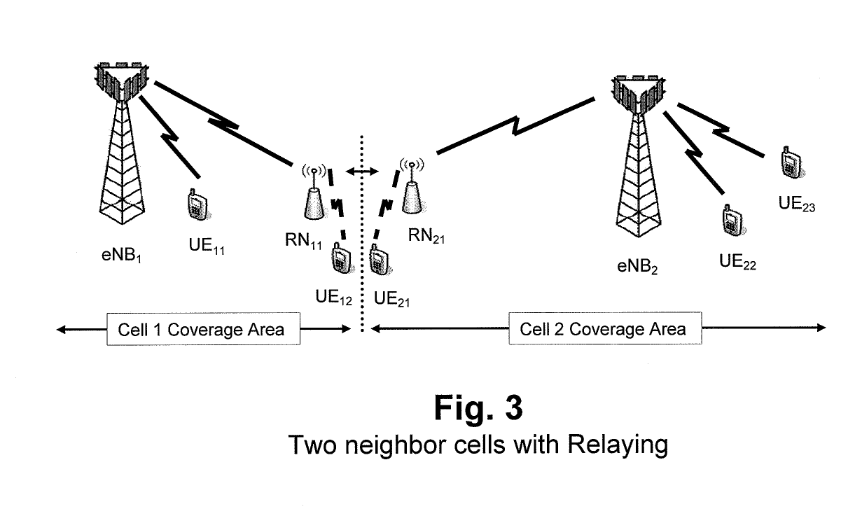

FIG. 3 shows a configuration of two neighboring cells in DL case. Two cells 1, 2 are shown each comprising a base station eNB1, eNB2, and relays or relay nodes RN 11, RN 12, respectively. As shown in FIG. 2, for the eNB to UE and eNB to relay transmission, the eight left-hand side sub-frames of FIG. 2 are or may be used. For the RN to UE transmission, the two right-hand side sub-frames are or may be used. As depicted the relays are located near the cell border to enhance the cell edge performance (cell edge data rate). If a relay node RN₁₁ should transmit to a user equipment UE₁₂ at the same time when the relay node RN₂₁ receives data from its eNB₂ the interference produced from nearby RN₁₁ at RN₂₁ would be very high and limit the achievable data rate between eNB₂ and RN₂₁ for feeding the RN₂₁. In FIG. 3, high interference between relay nodes RN₁₁ and RN₂₁ is shown by a double-headed arrow. In such a case, the achievable data rate from RN₂₁ to UE₂₁ would be limited by the relay link and not the access link and the enhancement in terms of cell edge performance may be small if any.

Basically, by introducing a TDD type multiplexing for the relay node RN similar issues and similar interference may result as usual for TDD systems. Further, TDD systems are known to work reliable if the switching point is synchronized among networks. Therefore network synchronization is advantageous for TDD systems and also for relaying systems with a TD (time division) component, even if the underlying duplexing mode is FDD.

If relays RN11, RN21 are not utilized then time synchronization of neighbor cells is optional and the system (LTE-A FDD) can be deployed and operated similar as a LTE Release 8 network.

In accordance with one or more embodiments of the invention a decentralized time synchronisation method, system, apparatus and software is provided for communication systems such as actual or future radio systems or mobile radio systems like LTE-A.

Reliable and robust base station synchronization is provided without need of using GPS receivers and network signaling. Of course such GPS receivers or network signaling may nevertheless be provided e.g. to augment the methods presented in the present description and drawings.

Furthermore, in accordance with one or more embodiments of the invention, base stations do not need to be able to do the synchronization, which would require extra hardware to enable them to listen to neighbouring base stations transmissions. Also UEs do not need to do measurements, so no provisions have to be done there which may otherwise be costly due to the high number of UEs and might also compromise battery standby time. This has the added benefit that synchronization can be performed without UEs, e.g. during the bootup-phase of the network when no UEs are yet allowed to connect or during low load situations, where insufficient numbers of UEs are present (e.g. during night in an industrial area).

In the above or below discussed embodiments, NodeBs or enhanced NodeBs, eNBs, are referred to. It is to be understood that the invention is not limited to such examples and that the invention may be applied to and used with any other kind of base stations such as base transceiver stations or base stations according to older 3GPP standards, etc, as well.

In accordance with one or more embodiments a decentralized synchronization scheme is provided. The decentralized synchronization scheme may utilize relays to measure the timing difference between neighbour cells.

To make the synchronization scheme more robust, in accordance with one or more embodiments of the invention, measurements to multiple neighbour eNBs and/or relays may be combined into one measurement information.

In accordance with one or more embodiments of the invention, one bit up and down commands may be used for timing update, or higher layer measurement reports may be used and exchanged between one or more relay nodes and one or more base stations such as eNB with multi-bit timing update command.

In accordance with one or more embodiments, a timing adaptation may be applied with a fixed small step size.

In accordance with one or more embodiments, the synchronization procedure may comprise one or more, in any arbitrary combination, of the following basic steps or functions which may e.g. all or to a larger part be done at the relay node.

The frame timing of the received LTE(-A) primary and secondary synchronization signal (PSS, SSS) of the cell the relay is connected to (base station Xₖ) is acquired at the relay.

Then if there is no data transmitted from eNB to the relay node or by the relay node to connected user equipments UEs (e.g. idle sub-frames) the relay node may search for PSS and SSS signals of neighbouring eNBs and/or relays not connected to the own feeding eNB.

Further if there is no data transmitted from eNB to the relay node and if there are no UEs camping or no UEs are connected to the relay node, the relay node can switch off the transmission of its own primary and secondary synchronization signal (PSS, SSS) and/or its broadcast channel, BCH, and/or the transmission of downlink (DL) pilot signals. Further switching on/off PSS, SSS and BCH may also be controlled by the feeding eNB.

The PSS and SSS of the relay node may also be unaligned to the eNB PSS and SSS transmission in time. So if for an eNB the PSS and SSS are located in sub-frame 1 and sub-frame 5 then for a relay node the PSS and SSS may be located e.g. in sub-frame 3 and sub-frame 7. In this way it is not necessary to switch off PSS and SSS. Basically this can be achieved by a timing offset of some integer number of subframes between the transmission of the RN and the eNB.

Then the timing difference to the primary and/or secondary synchronization signal (PSS,SSS) to each LTE(-A) neighbour eNB which is received with a power (received signal strength measurement) higher than the power of the cell the UE is camped or connected to minus an offset (e.g. 6-8 dB) may be evaluated. In case the network has already coarse synchronization achieved the own PSS and SSS signal or PSS and SSS from own eNB can be removed at the relay receiver utilizing interference cancellation techniques. This feature may depend on the used technology.

Then the timing difference to the primary and secondary synchronization signal (PSS,SSS) to each LTE(-A) neighbour relay node which is received with a power (received signal strength measurement) higher than the power of the cell the UE is camped or connected to minus an offset (e.g. 6-8 dB) is evaluated.

The above mentioned sequence of steps or functions may also be changed in any arbitrary manner.

In a further embodiment, the network (or the eNB to which the relay is connected) configures which neighbours a relay should use for calculation of timing difference value, e.g. to ensure that in case of new node insertion, the new node synchronizes to an already synchronized network, and avoid that the whole network tries to synchronize to the new node.

For measurement of received LTE frame timing difference a correlation based scheme can be used. A correlation to the PSS and SSS to the own cell and the neighbour PSS and SSS may be done.

In one or more embodiments, the timing difference values may e.g. be combined into a single timing difference value. As an example, the combined timing difference value is the sum or average or weighted average of the evaluated timing difference values from previous step(s).

Further steps at the relay may then be as follows.

If the combined timing value is equal to or greater than (≧) 0 (or greater than a defined value or threshold α) a time shift up command is signalled from the relay to the eNB via physical or higher layer signalling.

If the combined timing value is smaller than (<) 0 (or smaller than a defined value or threshold −α) a time shift down command is signalled from the relay to the eNB via physical or higher layer signalling.

In another embodiment with multi-bit higher layer reporting, the combined timing value is signalled from the relay to the eNB utilizing higher layer signalling (e.g. layer 2 measurement report from relay to eNB).

On the eNB side, the frame timing of base station Xₖ may be adapted according to the received time shift commands (time shift up or time shift down) from relay(s) e.g. as follows:

```
for each received time shift up command {
  t_{k, new} = t_{k, old} + K + gauss (0, ε)
  }
for each received time shift down command {
  t_{k, new} = t_{k, old} − K + gauss (0, ε)
  }
```

Or in case of layer 2 multi-bit measurement reports:

```
for each received layer2 measurement report {
  t_{k, new} = t_{k, old} + W × Δt
  }
```

where the parameter κ denotes the timing adaptation step size. Further here gauss(0,ε) is a random generator and the random numbers produced may be Gaussian distributed with mean zero and ε is the standard deviation and can be set e.g. to κ/10. Further w is a parameter e.g. smaller than (<) 1 to ensure that the decentralized synchronization procedure converges and does not oscillate.

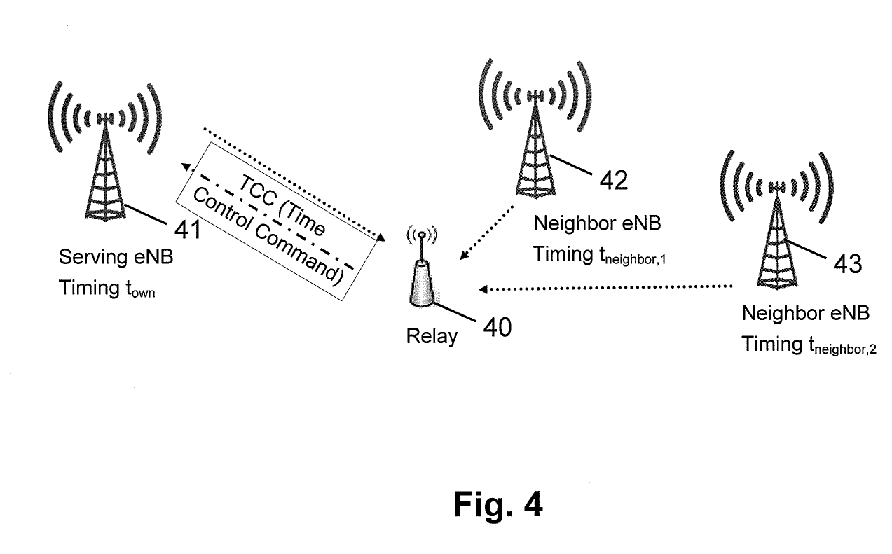

An example of the described synchronisation procedure embodiment is shown in FIG. 4. A relay 40 connected on its serving (feeding) eNB or base station 41 measures the timing difference to either predefined (by the network e.g. configured by the feeding eNB 41) neighbour eNBs 42, 43 and/or relays or to the strongest neighbour eNBs and/or relays and evaluates the time control command (TCC) which is +1/−1. The dotted lines in FIG. 4 indicate that relay 40 measures timing of downlink signals, e.g. DL PSS and SSS. The e.g. one bit information of the time control command is signalled to the serving eNB 41, as shown by a dot-and-dash line. The dot-and-dash line indicates UL signalling from relay 40 to eNB 41. Dependent on this time control information the serving eNB 41 can update its timing. If the serving eNB 41 receives multiple TCC commands from multiple relays a sum operation may be done considering e.g. the sum Σ TCC·κ+gauss(0,ε) instead of TCC·κ+gauss(0,ε). In this case the parameter κ can also serve to achieve a weighted average of the commands.

In a further embodiment a relay explicitly signals or implicitly indicates by cell ID and/or site ID to which eNB it is connected so that relay node can utilize besides eNBs also relays to achieve time synchronization to the eNB that feeds these relays (and is therefore synchronized to it) and to avoid that a relay node utilizes e.g. five relays connected to similar eNB for calculating the timing control command instead of utilizing five relays connected to different eNBs which gives better convergence of local time synchronization in the network. For this purpose it is necessary that the relay node indicates the feeding eNB or that this association is provided via separate signaling, e.g. a list showing an association of relays with feeding eNBs.

Measuring timing of five cells or RNs that are known to be synchronous among themselves may provide a somewhat better accuracy due to averaging, but this may not yet be relevant at least during the initial synchronization (coarse synchronization) when the measurement error is not yet a limiting factor.

In particular there is no point if the relay measures the timing of a relay that is connected to the same cell as itself, or that is connected to a cell that is already synchronized to its own cell, e.g. a neighbouring sector from the same site, because this timing would be synchronized anyhow already (termed similar eNB above). In accordance with one or more embodiments, existence of such cells and/or relays is checked e.g. based on cell ID or site ID, and by excluding such cells and subordinate relays from synchronization, the effort can be reduced.

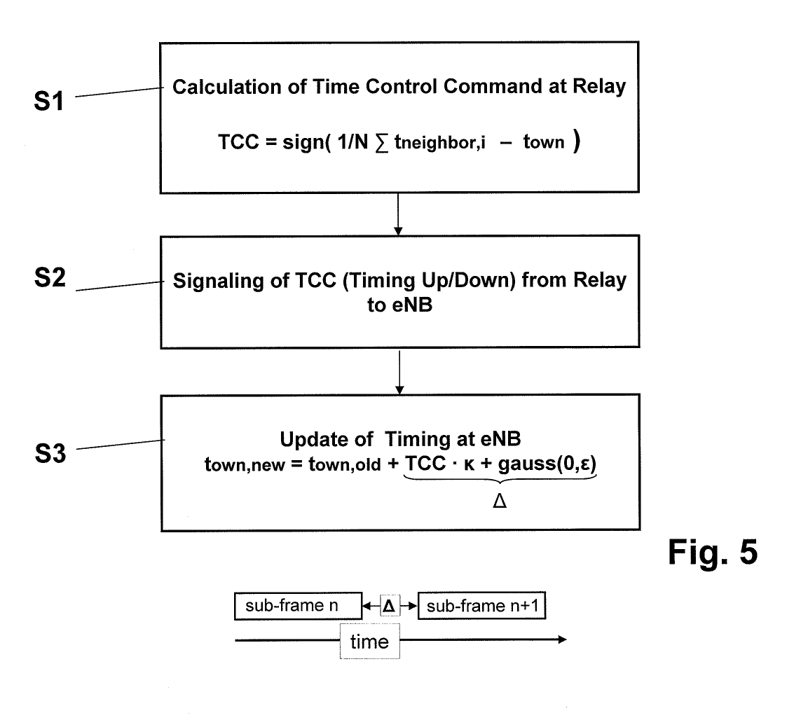

FIG. 5 shows an embodiment of a method in accordance with the invention. In a step, process or function S1, a time control command TCC is calculated at relay 40, e.g. according to a sum of timing differences, divided by the number of summed differences, or an equation:

TCC=sign(1/NΣt_{neighbor,i}−t_{own}).

Here sign( ) denotes the sign function, returning +1/−1 if the argument is greater than or less than 0.

In a step, process or function S2, the relay 40 signals the time control command TCC (e.g. Timing Up/Down) to the base station eNB 41.

In a step, process or function S3, the timing t_{own} at eNB 41 is updated, e.g. as follows:

t_{own,new}=t_{own,old}+Δ, or

t_{own,new}=t_{own,old}+TCC·κ+gauss(0,ε),

wherein Δ may e.g. correspond to TCC·κ+gauss(0,ε), or may have another value.

As shown in the lower half of FIG. 5, the timing of a sub-frame n+1 is shifted or delayed (or advanced) by Δ as compared to the timing of the preceding sub-frame n.

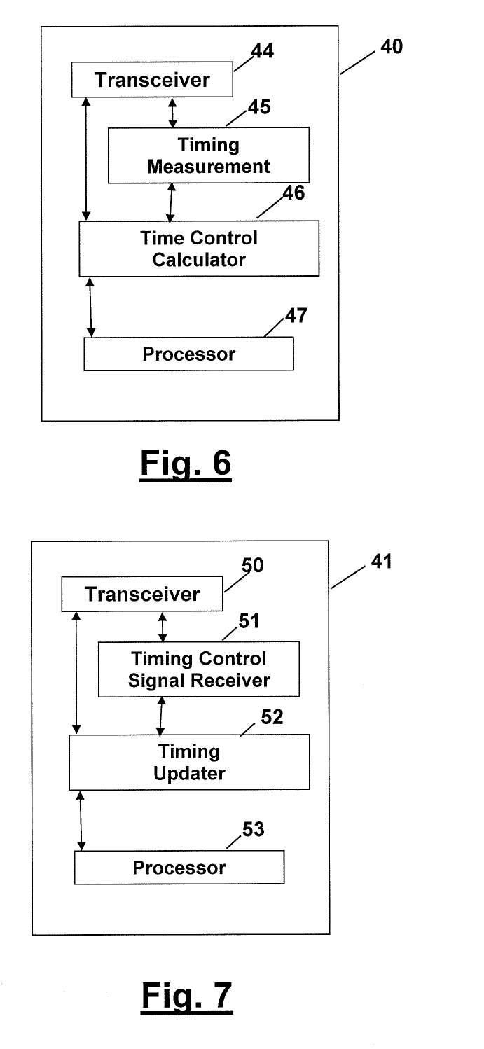

FIG. 6 illustrates an embodiment of a relay or relay node 40 in accordance with the invention. The relay 40 comprises a transceiver 44 for transmitting and receiving signals to and from e.g. a base station or eNodeB 41 or user equipment, etc., a timing measurement function, device or part 45 for measuring the timing of the own base station and/or one or more neighbouring base stations or relays, a time control calculator 46 for calculating and generating a time control signal e.g. in the manner as described above or below, and for sending the generated time control signal to the base station 41 via transceiver 44, and a processor 47 for signal processing and/or controlling one or more of the components of FIG. 6 or of the relay 40.

FIG. 7 shows an embodiment of a base station or eNB 41 in accordance with the invention. The base station 41 comprises a transceiver 50 for transmitting and receiving signals to and from e.g. the relay 40 or terminals, etc., a time control signal receiver 51 for receiving and evaluating the time control signal sent by the relay 40, a timing updater 52 for updating the internal time base or reference in accordance with the received time control command e.g. as described above or below, and a processor 53 for signal processing and/or controlling one or more of the components of FIG. 7 or of the base station or eNB 41.

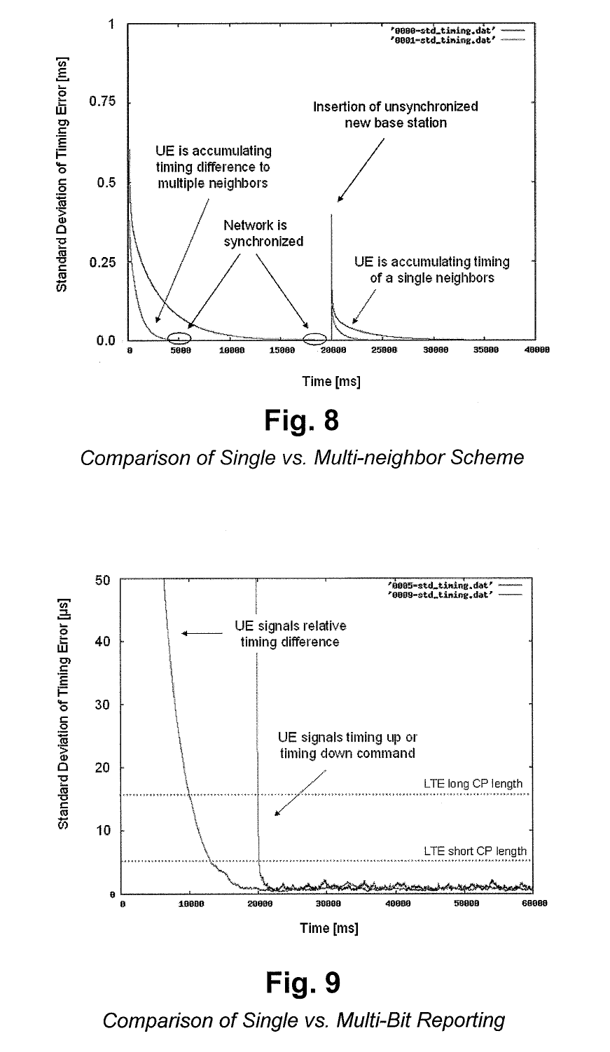

In FIG. 8 the performance of a decentralized over the air synchronisation algorithm in accordance with one or more embodiments of the invention is shown. A comparison of single versus multi-neighbor scheme is shown. The time difference measurement may e.g. be done in a conventional manner, as described e.g. in WO99/30519, or network time protocol, NTP standard, etc. For the red curve only a single neighbour cell is considered for the timing difference measurement at the relay node. As can be seen if multiple neighbour cells are considered the robustness and synchronization speed is better.

FIG. 9 shows a comparison of single versus multi-bit reporting. The performance of a single bit UL reporting scheme (signaling if timing is before or after timing of own cell) and a multi-bit (signaling of relative difference in timing) is shown.

It can be seen in FIG. 9 that the convergence of the multi-bit scheme is faster. However a remaining synchronisation uncertainty is similar. Further it was investigated that the multi-bit scheme may be less robust and parameter setting and optimization (w parameter) may be more difficult.

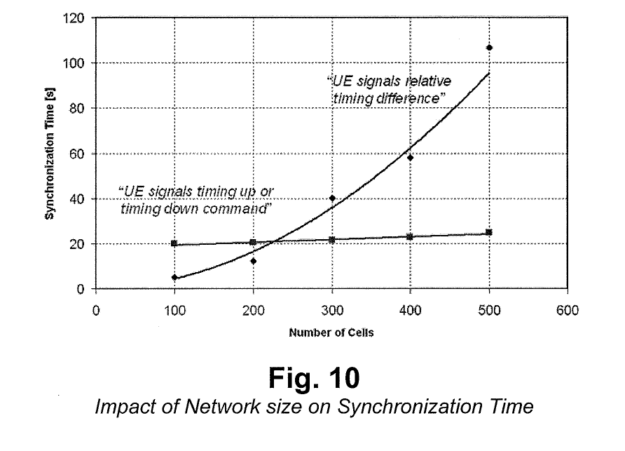

FIG. 10 shows in addition that the impact of network size (number of cells) on the needed synchronization time is lower for the single bit scheme. Shown in FIG. 10 is the needed synchronization time to achieve a time variance ≦1 μs in the whole network with the given number of cells (e.g. 100-500). In this basic investigation the propagation delay was neglected. However if relays are located at the cell edge then the distance from feeding eNB to relay node and neighbor eNB to relay node is similar and then propagation delay does anyhow not affect the results.

The described rules carried out by the relays or relay nodes how to determine the time shift command may be part of RAN standardization. Further signalling of parameters like configuration which neighbours a RN shall use for time difference measurement may be introduced to obtain correct functionality of the proposed schemes.

Implementations of the invention may e.g. be applied to LTE(-A) Relays and eNBs, as well as to other types of radio accesses or access networks such as 3GPP RAN, etc, e.g. to improve network performance.

The system or network architecture shown in FIGS. 3, 4, 6, 7 may also comprise other types of base stations other than eNBs such as nodeBs, or base transceiver stations, access points, etc.

In accordance with one or more embodiments of the invention a computer program product or software for carrying out one or more or all of the above described functions, processes or routines or claims is provided which may e.g. be embodied or stored on a computer-readable medium.

The system or network architecture shown in FIGS. 3, 4 and may e.g. have one or more of a serving GPRS, general packet radio service, support node, SGSN, a mobility management entity, MME, for managing mobility, UE identities and security parameters, a UMTS terrestrial radio access network, UTRAN, a GERAN, GSM/EDGE, Enhanced Data rate for GSM Evolution, radio access network, E-UTRAN, a HS, a serving gateway e.g. for terminating an interface towards E-UTRAN, a PDN gateway being a node that terminates an SGi interface towards a packet data network, PDN, a PCRF, and operator's IP services (e.g. IMS, PSS etc.).

For the purpose of the present invention as described herein above, it should be noted that any access or network technology may be used which may be any technology by means of which a user equipment can access a network. The network may be any device, unit or means by which a mobile or stationary entity or other user equipment may connect to and/or utilize services offered by the network. Such services may include, among others, data and/or (audio-) visual communication, data download etc.

Generally, the present invention is also applicable in network/terminal environments relying on a data packet based transmission scheme according to which data are transmitted in data packets and which are for example based on the Internet Protocol IP. The present invention is, however, not limited thereto, and any other present or future IP or mobile IP version, or, more generally, a protocol following similar principles is also applicable. The user equipment entity may be any device, unit or means by which a system user may experience services from a network.

The sequence of method steps described above or shown in the drawings can be implemented in any other sequence arbitrarily deviating from the above described or shown sequence of steps. Further, the method, apparatuses and devices, may include only one, more or all of the features described above or shown in the drawings, in any arbitrary combination.

The method steps may be implemented as software code portions and be run using a processor at a network element or terminal, can be software code independent, or can be specified using any known or future developed programming language as long as the functionality defined by the method steps is preserved. Generally, any method step is suitable to be implemented as software or by hardware without changing the idea of the present invention in terms of the functionality implemented. Devices, apparatus, units, or means, and/or method steps may be implemented as hardware components of a stationary or mobile station, or a terminal, or a network element, or part, or chipset, or module thereof, which part, or chipset, or module e.g. be used for an apparatus; may be hardware independent; and may be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. Devices, apparatus, units or means (e.g. User equipment, CSCF) can be implemented as individual devices, units, means, chipsets, modules, or part of devices, and may also be implemented in a distributed fashion throughout a system, as long as the functionality of the device, unit or means is preserved.

1. An apparatus configured to
measure a timing difference to at least one neighbouring base station, cell, NodeB, enhanced NodeB, and/or relay,
evaluate or generate a time control command depending on the measured timing difference, and
send the time control command to a serving base station or NodeB or enhanced NodeB.

2. Apparatus according to claim 1, wherein the time control command is a single-bit or multi-bit command.

3. Apparatus according to claim 1, wherein the apparatus is configured to measure timing of downlink signals, or primary and secondary synchronization signals.

4. Apparatus according to claim 1, wherein the apparatus is a relay or part, module, chipset, or software of a relay.

5. Apparatus according to claim 1, wherein the apparatus is configured to be connected to its serving or feeding NodeB or enhanced NodeB or base station.

6. Apparatus according to claim 1, configured to signal or indicate, e.g. by cell identity or site identity, to which base station or NodeB or enhanced NodeB it is connected, and utilize at least one or more of base stations or NodeBs and relays to achieve time synchronization.

7. Apparatus configured to receive a time control information and to update its timing depending on the received time control information.

8. Apparatus according to claim 7, configured to receive at least two time control information from at least two relays, and to process, such as sum or average or weighted average, the received at least two time control information.

9. Apparatus according to claim 7, configured to shift or delay the timing of a sub-frame to provide synchronization.

10. Apparatus according to claim 7, wherein the apparatus is a relay or part, module, chipset, or software of a base station, NodeB or enhanced NodeB.

11. A method, comprising measuring a timing difference to at least one neighbouring base station, cell, NodeB, relay and/or relays, evaluating or generating a time control command depending on the measured timing difference, and sending the time control command to a serving base station or NodeB or enhanced NodeB.

12. A method according to claim 11, comprising at least one or more, in any arbitrary combination, of the following:
the time control command is a single-bit or multi-bit command,
measuring timing of downlink signals, or primary and secondary synchronization signals;
implementing the method in a relay or part, module, chipset, or software of a relay,
connecting a relay to its serving or feeding NodeB or enhanced NodeB or base station,
signaling or indicating, e.g. by cell identity or site identity, to which base station or NodeB or enhanced NodeB it is connected, and
utilizing at least one or more of base stations and relays to achieve time synchronization.

13. Method, comprising receiving a time control information, and updating a timing depending on the received time control information.

14. Method according to claim 13, comprising at least one or more, in any arbitrary combination, of the following:
receiving at least two time control information from at least two relays,
processing, such as summing or averaging or weighted averaging, the received at least two time control information,
shifting or delaying the timing of a sub-frame to provide synchronization,
implementing the method in a base station or part, module, chipset, or software of a base station, NodeB or enhanced NodeB.

15. Computer program product, comprising code means configured to carry out or implement, when run on a processor, a method as defined in claim 11.
